(19) United States
(12) Patent Application Publication
(10) Pub. No.: US 2008/0135183 A1
(43) Pub. Date: Jun. 12, 2008

(54) Tool for Sticking Tape for a Linear Device

(76) Inventors: Fu-Yuan CHANG, Taichung (TW); Ming-Chih Huang, Taichung (TW)

Correspondence Address: Dr. BANGER SHIA, 102 Lindencrest Ct., Sugar Land, TX, 77479-5201, US

(21) Appl. No.: 11/567,712

(22) Filed: Dec. 6, 2006

(51) Int. Cl. B32B 38/18

(52) U.S. Cl. 156/577

(57) ABSTRACT

A tool for sticking tape for a linear device is disposed on a mover of a linear device and comprises: a body, a guiding roller assembly, and a press roller assembly. The body is formed with an inlet and an outlet, and the guiding roller assembly and the press roller assembly are disposed in the body. The guiding roller assembly serves to guide the tape into the body via the inlet, and the press roller assembly is employed to guide and press the tape onto a predetermined surface, so that the tape is positioned quickly and precisely. The tape serves as magnetism induced, infrared or contact induction ruler of the linear device.

### BACKGROUND OF THE INVENTION

1. Field of the Invention

The present invention relates to a component of a linear device, and more particularly to a tool for sticking tape for a linear device, which can stick the tape quickly and precisely.

2. Description of the Prior Art

Nowadays, linear transmission device is used more and more widely in modern industries, and the linear transmission device generally includes linear guideway and ball screw. In addition to the effect of high precision, the linear transmission device also has the advantages of low frictional loss, high energy conversion ratio, low noise and high rigidity. Hence, it is self-evident that the linear transmission means is very important to various industrial mechanisms.

Most of the existing linear transmission devices are stuck on the travel path of the mover with an induction tape (which is generally of magnetic induction type, infrared, or contact type). The induction tape is used to enable the control system to obtain the mover's precise position, and to execute various action controls. The existing methods for installing the various abovementioned induction tapes are nothing more than manually sticking while watching with eye, manually sticking by marking, and manually sticking after milling a track. However, all these methods have their own disadvantages:

Firstly, when manually sticking the tape while watching with eye or by marking, the sticking operation is likely to be affected by the worker's visual error or action error, and must be adjusted for several times, thus the sticking operation cannot be finished in a single step. This will usually cause quality problem—the tape is slant, and will lead to an error in the effective distance between the induction portion of the induction tape and the induction head of the control system, and as a result, the induction tape can't work properly.

Second, the method of manually sticking after milling a track can enable the tape to be stuck precisely, however, it requires the processes of measuring, calibration, milling, and track cleaning, therefore, it is time-consuming and high cost.

Third, induction tape is normally laminated on its surface with a protective layer, and the protective layer cannot be guided by the track and is likely to be slanted. Further, the method of manually sticking the tape while watching with eye or by marking will have a more serious adverse effect on the protective layer.

Therefore, how to develop an improved and competitive tape-sticking product is the common goal that the manufactures are striving for.

The present invention has arisen to mitigate and/or obviate the afore-described disadvantages.

### SUMMARY OF THE INVENTION

The primary objective of the present invention is to provide a tool for sticking tape for a linear device that can finish the tape sticking operation in a single step.

The secondary objective of the present invention is to provide a tool for sticking tape for a linear device that can stick the tape quickly and repeatedly.

Another objective of the present invention is to provide a tool for sticking tape for a linear device that can peel off the film automatically.

To obtain the abovementioned objective, the tool for sticking tape for a linear device in accordance with the present invention is disposed on the mover of the linear device, and comprises:

a body formed with an inlet and an outlet, and in the body is disposed a scraper for peeling off the film;

a guiding roller assembly and a press roller assembly mounted on the body, the guiding roller assembly serves to guide the tape into the body via the inlet, and the press roller assembly is employed to guide and press the tape onto a predetermined surface.

### BRIEF DESCRIPTION OF THE DRAWINGS

FIG. 1 shows that a tool for sticking tape for a linear device in accordance with the present invention is fixed on a slide block of a linear device;

FIG. 2 is an assembly cross sectional view of the tool for sticking tape for a linear device in accordance with the present invention;

FIG. 3 is an operational cross sectional view of the tool for sticking tape for a linear device in accordance with the present invention;

FIG. 4 is a partially amplified view of showing the operation of the tool for sticking tape for a linear device in accordance with the present invention; and

FIG. 5 is an illustrative view in accordance with the present invention of showing that the tape is being stuck onto the predetermined surface.

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

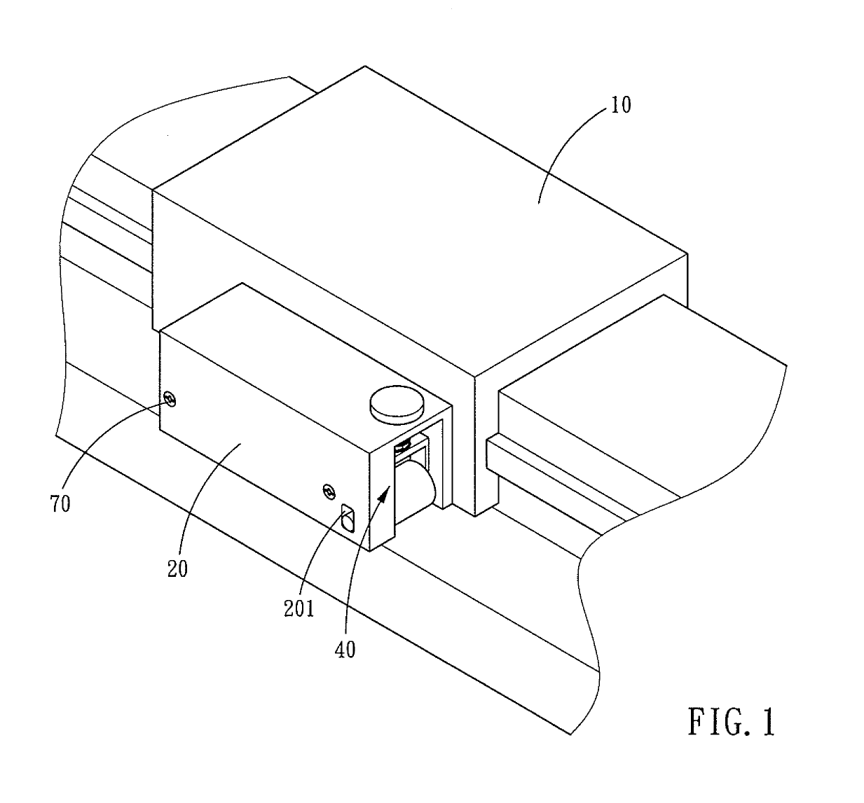

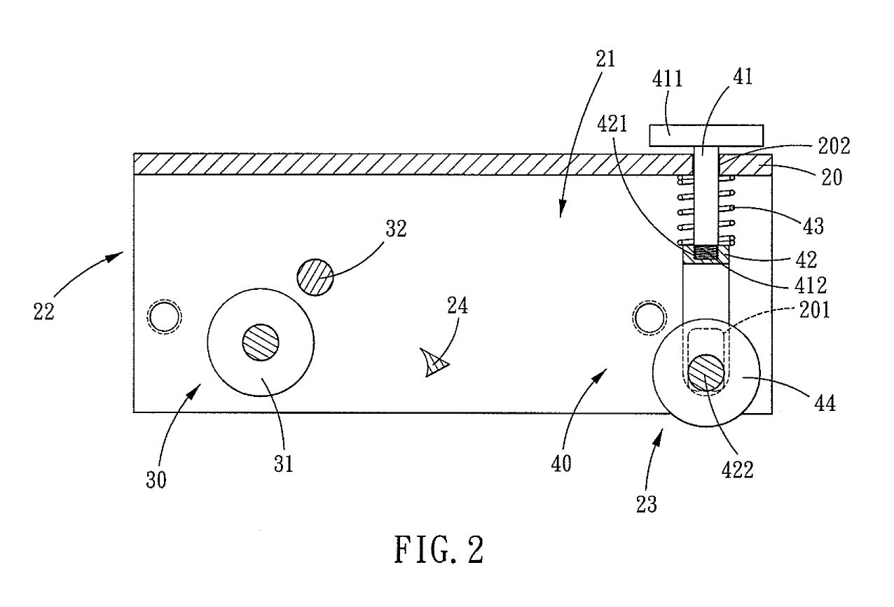

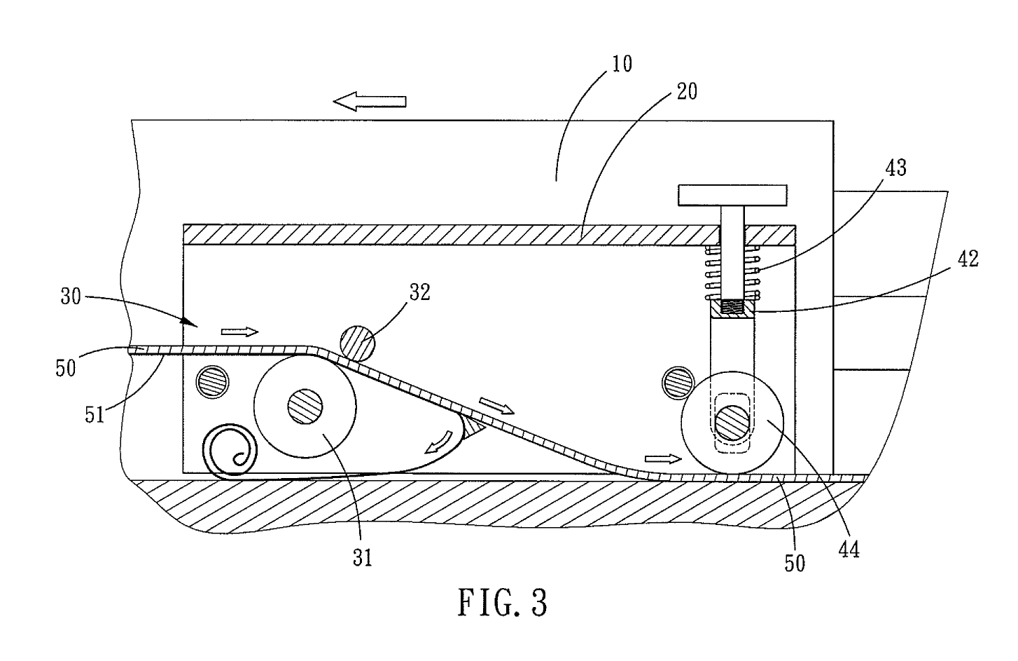

Referring to FIGS. 1-3, a tool for sticking tape for a linear device in accordance with the present invention is fixed to a side of the slide block 10 on a linear guideway by screws 70 (the slide block is a mover, and the linear guideway is a stator) and cooperates with the slide block 10 to transport tape 50 laminated with a film 51. The tool for sticking tape comprises: a body 20, a guiding roller assembly 30, and a press roller assembly 40.

The body 20 is a casing having a receiving space 21 and is defined with an inlet 22 and an outlet 23 located at both sides of the body 20. The tape 50 is fed into the body 20 via the inlet 22, and the outlet 23 is open toward a predetermined surface on which the tape 50 is to be stuck. A guiding hole 201 is formed in either side surface of the body 20 and is located outside the outlet 23, and an adjusting hole 202 is formed in the top surface of the body 20 above the outlet 23. In the receiving space 21 is disposed a scraper 24 for peeling off the film 51, and the scraper 24 is located between the inlet 22 and the outlet 23.

The guiding roller assembly 30 is disposed in the receiving space 21 and located correspondingly to the inlet 22. The guiding roller assembly 30 includes at least a guiding roller 31 and an oppositely arranged stop pin 32 that cooperate with each other to clamp the tape 50 and feed it toward the outlet 23.

The press roller assembly 40 is disposed in the receiving space 21 and located correspondingly to the outlet 23 and includes at least an adjusting rod 41, a roller-mounting seat 42, a spring 43, and a press roller 44.

One end of the adjusting rod 41 is a circular rotating handle 411, and the other end of the adjusting rod 41 is formed with threads 412. The end of the adjusting rod 41 with the threads 412 is inserted from the top of the body 20 into the adjusting hole 202.

The roller-mounting seat 42 is disposed in the receiving space 21 of the body 20 and is provided with a shaft 422 to be inserted into the guiding holes 201 at both sides of the body 20. The guiding holes 201 limit the movement of the shaft 422 and the roller-mounting seat 42. A threaded hole 421 is formed in the roller-mounting seat 42 for engaging with the threads 412 of the adjusting rod 41.

The spring 43 is mounted onto the outer periphery of the adjusting rod 41 and is biased between the roller-mounting seat 42 and the inner surface of the body 20.

The press roller 44 is inserted on the shaft 422 and is located in the outlet 23 of the body 20. With the aid of the spring 43, the press roller 44 presses the tape 50 onto the predetermined surface while peeling off the film 51.

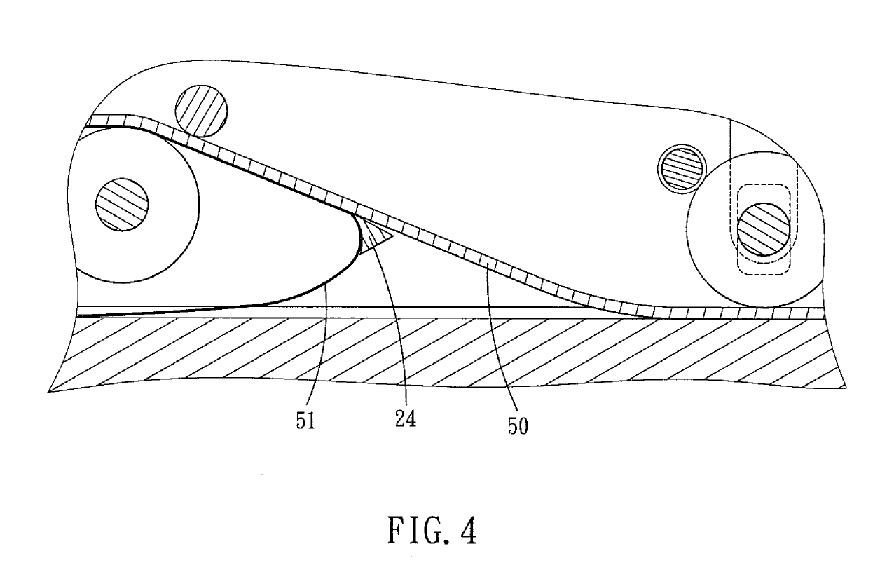

As shown in FIG. 4, when the tool for sticking the tape moves along with the slide block 10 of the linear guideway, the press roller 44 will keep peeling off the film 51 while pressing the tape 50 from the outlet 23 onto the predetermined surface, and the precise linear movement of the sliding block 10 ensures that the tape 50 can be stuck linearly and precisely, and the operation of tape sticking and film-peeling can be executed simultaneously by the tape-sticking tool, thus effectively reducing labor cost and working time.

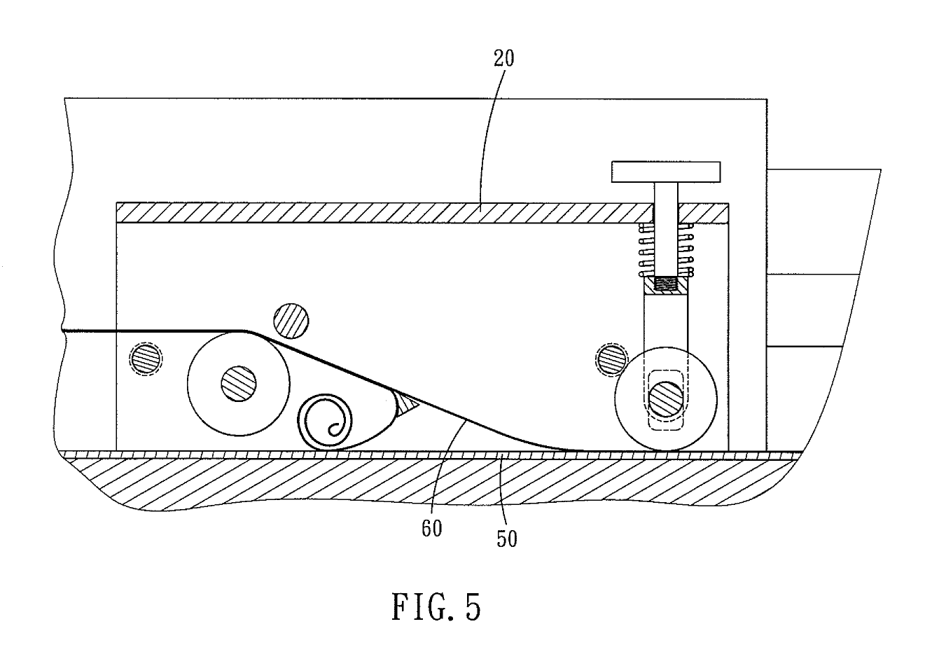

FIG. 5 shows another embodiment of the present invention, the tool in accordance with the present invention can also be used to stick the metal-made protective tape 60, allowing the protective tape 60 to be directly stuck on the induction tape 50. The precise linear movement of the sliding block 10 ensures that the tape 50 can be stuck linearly and precisely, and the operations of tape sticking and film-peeling can be executed simultaneously by the tape-sticking tool, thus effectively reducing labor cost and working time, and preventing the error caused by repeated sticking operation.

To summarize, the present invention is disposed on the mover of a linear device and comprises: a body, a guiding roller assembly, and a press roller assembly. The body is formed with an inlet and an outlet, and the guiding roller assembly and the press roller assembly are disposed in the body. The guiding roller assembly serves to guide the tape into the body via the inlet, and the press roller assembly is employed to guide and press the tape onto a predetermined surface, so that the tape is positioned quickly and precisely. The tape serves as magnetism induced, infrared or contact induction ruler of the linear device.

While we have shown and described various embodiments in accordance with the present invention, it is clear to those skilled in the art that further embodiments may be made without departing from the scope of the present invention.

What is claimed is:

1. A tool for sticking tape for a linear device being disposed on a mover of the linear device and serving to sticking tape, comprising:
a body being a casing with a receiving space and formed with an inlet and an outlet for the tape, the inlet and the outlet being located at both sides of the body, the tape is fed into the body via the inlet, and the outlet being open toward a predetermined surface on which the tape is to be stuck;
at least one press roller assembly being disposed in the receiving space of the body and located correspondingly to the outlet, the press roller assembly serving to guide and press the tape onto the predetermined surface.

2. The tool for sticking tape for a linear device as claimed in claim 1 further comprising a guiding roller assembly being disposed in the receiving space of the body and located correspondingly to the inlet, and the guiding roller assembly serves to guide and transport the tape to the outlet.

3. The tool for sticking tape for a linear device as claimed in claim 2, wherein the guiding roller assembly includes a guiding roller and an oppositely arranged stop pin that cooperate with each other to clamp the tape.

4. The tool for sticking tape for a linear device as claimed in claim 1, wherein:
a guiding hole is formed in either side surface of the body and is located outside the outlet, and an adjusting hole is formed in the top surface of the body above the outlet;
the press roller assembly includes at least one adjusting rod, one roller-mounting seat, one spring, and one press roller, one end of the adjusting rod is a circular rotating handle, the other end of the adjusting rod is formed with threads, the end of the adjusting rod with the threads is inserted from a top of the body into the adjusting hole; the roller-mounting seat is disposed in the receiving space of the body and is provided with a shaft to be inserted into the guiding holes at both sides of the body, the guiding holes limit movement of the shaft and the roller-mounting seat, a threaded hole is formed in the roller-mounting seat for engaging with the threads of the adjusting rod; the spring is mounted onto an outer periphery of the adjusting rod and is biased between the roller-mounting seat and an inner surface of the body; the press roller is inserted on the shaft and is located in the outlet of the body, with the aid of the spring, the press roller presses the tape onto the predetermined surface while peeling off film of the tape.

5. The tool for sticking tape for a linear device as claimed in claim 3, wherein:
a guiding hole is formed in either side surface of the body and is located outside the outlet, and an adjusting hole is formed in the top surface of the body above the outlet;
the press roller assembly includes at least one adjusting rod, one roller-mounting seat, one spring, and one press roller, one end of the adjusting rod is a circular rotating handle, the other end of the adjusting rod is formed with threads, the end of the adjusting rod with the threads is inserted from a top of the body into the adjusting hole; the roller-mounting seat is disposed in the receiving space of the body and is provided with a shaft to be inserted into the guiding holes at both sides of the body, the guiding holes limit the movement of the shaft and the roller-mounting seat, a threaded hole is formed in the roller-mounting seat for engaging with the threads of the adjusting rod; the spring is mounted onto an outer periphery of the adjusting rod and is biased between the roller-mounting seat and an inner surface of the body; the press roller is inserted on the shaft and is located in the outlet of the body, with the aid of the spring, the press roller presses the tape onto the predetermined surface while peeling off film of the tape.

6. The tool for sticking tape for a linear device as claimed in claim 1, wherein a scraper is disposed in the receiving space of the body for peeling off the film, and is located between the inlet and the outlet.

7. The tool for sticking tape for a linear device as claimed in claim 2, wherein a scraper is disposed in the receiving space of the body for peeling off the film, and is located between the inlet and the outlet.

8. The tool for sticking tape for a linear device as claimed in claim 3, wherein a scraper is disposed in the receiving space of the body for peeling off the film, and is located between the inlet and the outlet.

9. The tool for sticking tape for a linear device as claimed in claim 4, wherein a scraper is disposed in the receiving space of the body for peeling off the film, and is located between the inlet and the outlet.

10. The tool for sticking tape for a linear device as claimed in claim 5, wherein a scraper is disposed in the receiving space of the body for peeling off the film, and is located between the inlet and the outlet.
